(19) United States
(12) Patent Application Publication
(10) Pub. No.: US 2003/0227224 A1
(43) Pub. Date: Dec. 11, 2003

(54) Wheel generator structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/164,004

(22) Filed: Jun. 7, 2002

(51) Int. Cl. H02K 17/00

(52) U.S. Cl. 310/75 C; 310/166

(57) ABSTRACT

A wheel generator structure comprises a body, a generator and loads. This design is to secure a large gear on the inner side of a wheel and the generator has an idle gear on one side of a spindle, the idle gear meshes with the large gear. Due to a differential ratio of the gears, when the speed of the wheels slow down, an inductive coil and a magnet will remain a regular spinning speed to generate electricity in a constant manner.

### FIELD OF THE INVENTION

This invention relates to a wheel generator structure, and more particularly, to a generator maintains a constant output of electricity.

### BACKGROUND OF THE INVENTION

Some bicycles, tricycles, roller skates on the market are equipped with electricity to activate a light or a sound device as a decorative ornament. However, due to the size of the wheels, the electricity they generated is relatively weak to drive the device, and therefore can hardly attract consumers' attention.

In view of this, the inventor has derived the present invention to improve the shortcomings.

### SUMMARY OF THE INVENTION

It is the primary object of the present invention to provide a wheel generator structure, which uses gear teeth differential to maintain regular spin speed of an inductive coil with respect to a magnet to produce constant electricity.

It is another object of the present invention to provide a wheel generator structure, which generates light and sound effects to attract consumers.

It is a further object of the present invention to provide a wheel generator structure, which is applicable to a bicycle, a tricycle, a roller skate or any other toddler's vehicle.

### BRIEF DESCRIPTION OF THE DRAWINGS

FIG. 1 is a partial view of a scooter incorporated with the present invention;

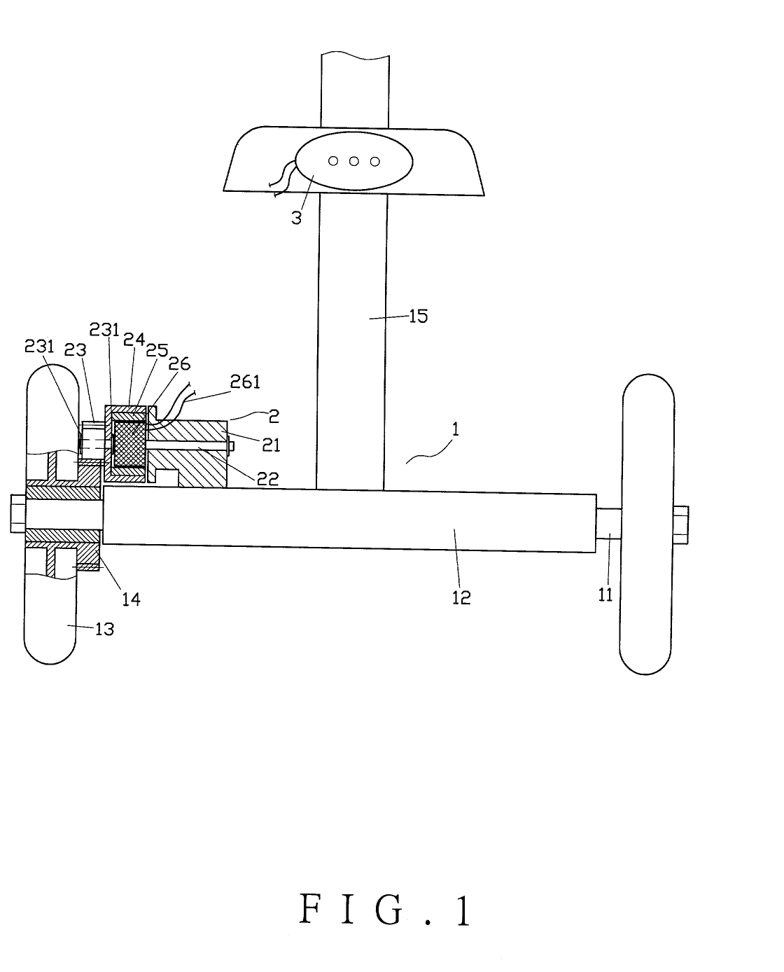

FIG. 2 is an enlarged view of FIG. 1, partially sectioned;

FIG. 3 is an enlarged view of a second embodiment of the present invention; and

FIG. 4 is a view of the present invention, which is applicable to be incorporated on to a bicycle, a tricycle, or a roller skate.

### DETAILED DESCRIPTION OF THE PREFERRED EMBODIMENTS

The wheel generator structure of the present invention comprises a body 1, a generator 2 and loads 3.

The body 1 may be a skateboard with an axle 11 thereon, which is covered with a sleeve 12. Both ends of the axle 11 are connected to wheels 13. One of wheels 13 has a large gear 14 connected at the inside thereof, and the axle 11 is secured to the bottom end of a front support 15.

The generator 2 is secured on the sleeve 12, having a support frame 21 secured on the sleeve 12 with a spindle 22 extending from inside of the inner portion outwardly. One end of the spindle 22 is pivoted with an idle gear 23 by a pair of retaining rings 231. The idle gear 23 meshes with the large gear 14 and is covered by a sleeve 24 which has a magnet 25 at the inner end, and the spindle 22 has an inductive coil 26 enclosed by the magnet 25, in such a manner that the inductive coil 26 spins within the magnet. The inductive coil 26 is connected with electric wires 261.

The load 3, which may be a LED or a sounding device, is mounted on the body 1 and activated by the generator 2 through electric wires 261.

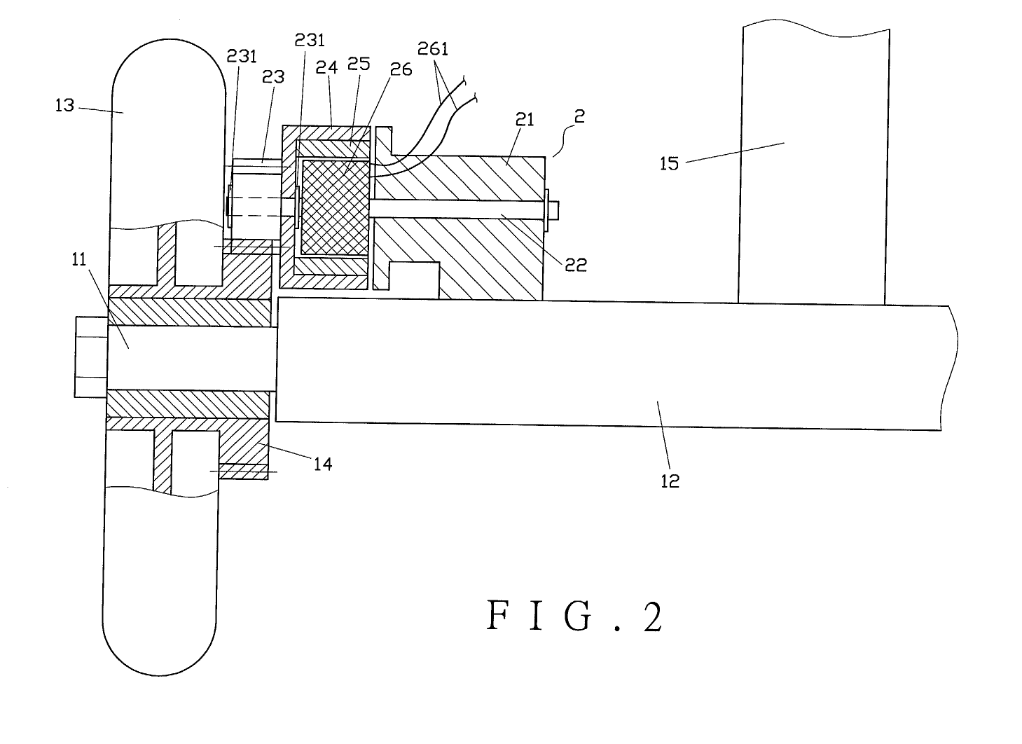

To operate the present invention, as shown in FIG. 2, when rolling the wheels 13, the large gear 14 is driven to spin, which drives the idle gear 23 to spin simultaneously, this brings the magnet 25 in the sleeve 24 to spin with respect to the inductive coil 26 to generate electricity, which then output to the load 3 through the electric wires 261.

Due to the differential ratio of the teeth between the large gear 14 and the idle gear 23, even the wheel rolling in a slow speed, the idle gear 23 still maintains a regular speed through the large gear 14, and therefore, outputs a constant and stable electricity.

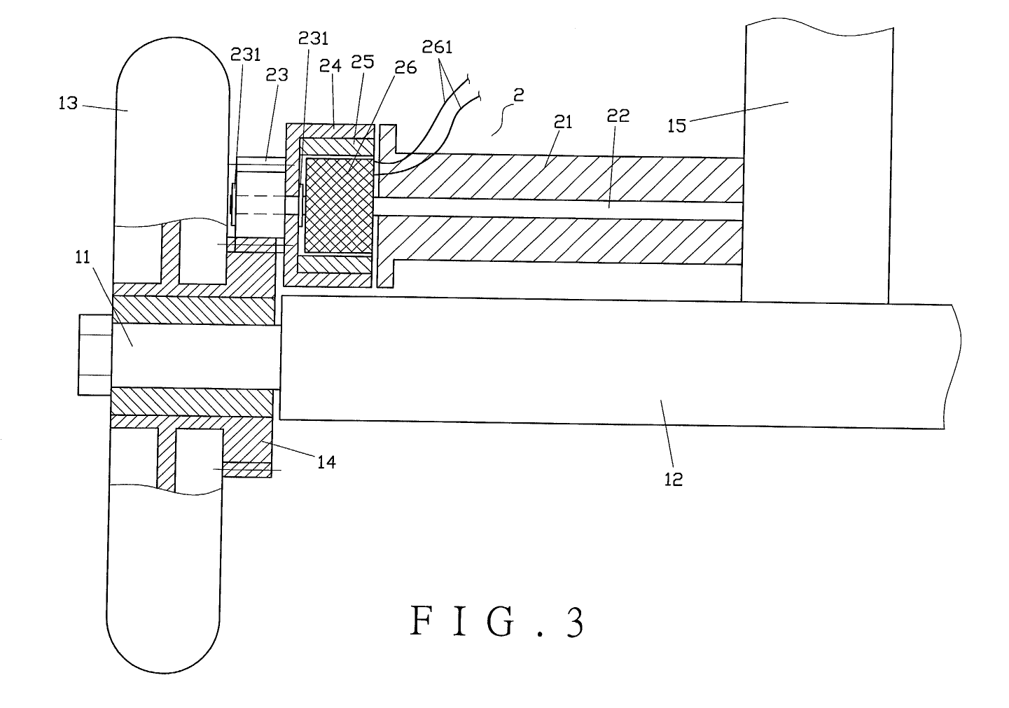

Another embodiment of the present invention is shown as in FIG. 3, which extends the support frame 21 of the generator 2 to the front support 15 of the body 1 to provide a better supporting effect.

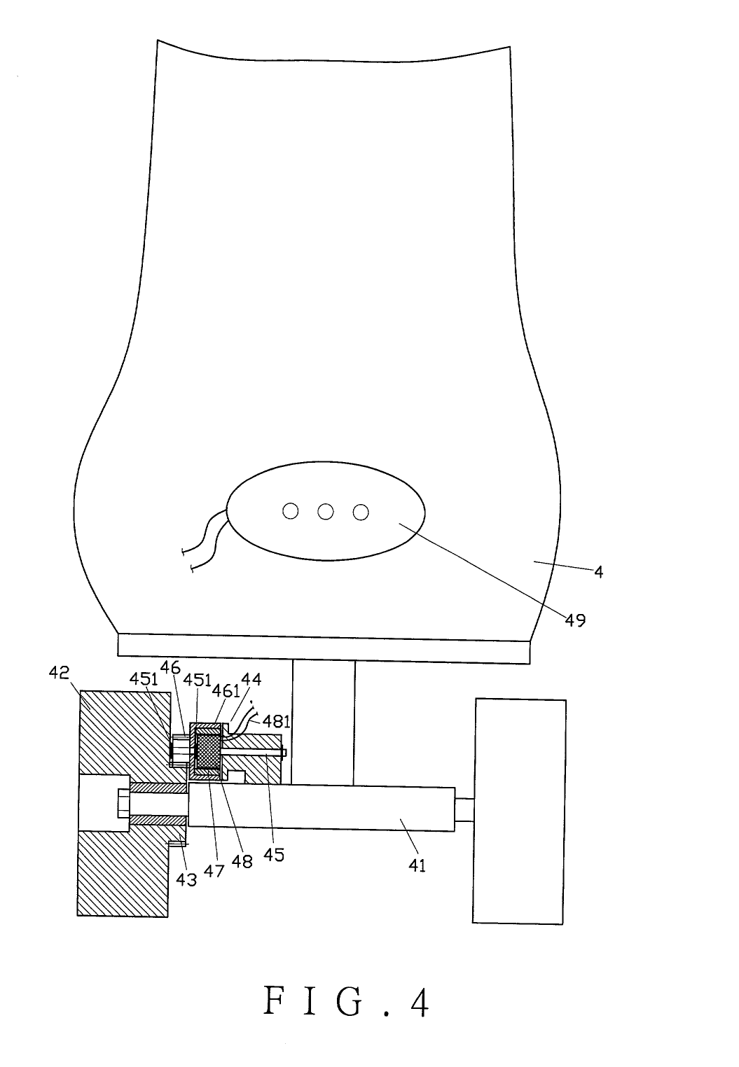

This design is applicable to be applied on a roller skate, a tricycle, a bicycle or a skateboard, anything with wheels, as shown in FIG. 4. A roller skate 4 has a pair of wheels 42 secured on respect sides of an axle 41, a generator 44 is secured on the axle 41 with a spindle 45 extending outwardly, and one end of the spindle 45 is secured with an idle gear 46 by a pair of retaining rings 451. One of the wheels 42 has a large gear 43 which meshes with the idle gear 46. The idle gear 46 has a sleeve 461 which comprises a magnet 47 secured therein. The spindle 45 has an inductive coil 48 corresponding to and enclosed in the magnet 47 and the inductive coil 48 is connected with electric wires 481. The connection is in such a manner, that when the magnet 47 spins, the magnetic field generates electricity, which then output through the electric wires 481 to a load 49.

I claim:

1. A wheel generator structure comprising a body, a generator, and loads, wherein:
said body comprising an axle having a sleeve thereon, said axle having secured with a pair of wheels at respect ends, and said body comprising a front support;
said generator being secured on said sleeve, comprising a support frame,
said support frame being secured on said sleeve and having a spindle therein;
said load being secured on said body, said load being LED or sounding devices and being driven by electricity from said generator, and being characterized in that,
one of said wheels being secured with a large gear, and one end of said spindle of said generator providing an idle gear meshing with said large gear, said idle gear having a sleeve with a magnet secured therein, said spindle having an inductive coil corresponding to and enclosed in said magnet of said idle gear so that said inductive may spin in said magnet, said inductive coil being connected with electric wires.

2. The wheel generator structure, as recited in claim 1, wherein said idle gear is pivoted on said spindle by a pair of retaining rings thereon.

3. The wheel generator structure, as recited in claim 1, wherein said support frame of said generator is secured to said front support for a strong support.
